(19) United States
(12) Patent Application Publication
(10) Pub. No.: US 2002/0027325 A1
(43) Pub. Date: Mar. 7, 2002

(54) Method of and implement for sealing a slot

(76) Inventors: Markus Kogler, Buchloe (DE); Silvia Huber, Neusass (DE); Peter Vogel, Untermeitingen (DE); Heiri Nuesch, Sevelen (CH)

Correspondence Address: DAVID TOREN, ESQ., SIDLEY, AUSTIN, BROWN & WOOD, LLP, 875 THIRD AVE, NEW YORK, NY, 10022, US

(21) Appl. No.: 09/942,383

(22) Filed: Aug. 29, 2001

(30) Foreign Application Priority Data
Sep. 1, 2000 (DE) 100 43 192.5

(51) Int. Cl. F16J 3/00

(52) U.S. Cl. 277/315; 277/628

(57) ABSTRACT

A method of and an implement for sealing a space (4) between an inner wall of a leadthrough (2) formed in constructional component (1) and at least one object (3) extending through the leadthrough (2) and including providing a support member (6; 15) fixedly and sealingly attachable to the constructional component (1), and a resilient diaphragm (7; 16) for sealingly connecting the support member (6; 15) with the constructional component (1).

### BACKGROUND OF THE INVENTION

1. Field of the Invention

The present invention relates to a method of and an implement for sealing a space between an inner wall of a leadthrough formed in a constructional component and a strand-like object extending through the leadthrough.

2. Description of the Prior Air

When a pipe or a cable is inserted through a leadthrough formed in a wall of, e.g., a housing from outside in, as a rule, a hollow space or a slot is formed between the wall and the pipe or cable and which has to be sealed with different means. For one, a mechanical sealing can be used. When a mechanical sealing is used, solid sealing elements are inserted into the hollow space or the slot and seal the same by forming a form-locking connection or by being compressed between the wall and the object. On the other hand, a pure chemical sealing can be used. When a pure chemical sealing is used, the hollow space or the slot is filled with reactive chemical systems which harden and close the hollow space or the slot. For chemical sealing, inorganic systems such as mortar or the like or organic systems such as, e.g., sealing masses, polymeric foams or the like are used. Also, a chemico-mechanical sealing can be used. When a chemico-mechanical sealing is used, as a rule, a mechanical sheeting of the end surfaces of the hollow spaces or slots takes place, with the panel elements containing chemical filing systems.

Mechanical solutions are expensive and time- and labor-consuming. When a mechanical system is used, as a rule, it should be designed for predetermined diameters of the pipe or cable and the wall opening. Chemical solutions, with which the annular slot is filled with a sealing mass, foam or mortar, do not have the above-discussed drawback of the mechanical system. However, a chemical system does not insure a lasting sealing against moisture or liquid such as, e.g., water. For one, this results to a great extent from the permeability of the material themselves, e.g., when an open-cell cellular material, such as foam, is used. The permeability can also be caused by incomplete adhesion of the chemical mass to different constructional components, or by failure of the operator to completely foam up the space or the slot.

Accordingly, an object of the present invention is to provide a method of and an implement for sealing a space or a slot between wall of a leadthrough and an object extending through the leadthrough which would provide simple means for a rapid and reliable sealing of the space or slot.

Another object of the present invention is to provide a method of and an implement for sealing the space or the slot between the wall and the object which would insure a lasting sealing against penetration of moisture or fluid such as, e.g., water.

### SUMMARY OF THE INVENTION

These and other objects of the present invention, which will become apparent hereinafter, are achieved by providing a method which includes providing a sealing implement having a support member and a resilient diaphragm stretching across the support member, sealingly connecting the support member with the constructional component, and pushing the object through the diaphragm and into the leadthrough formed in the constructional component or, alternatively, first, mounting the sealing implement on an end of the object projecting from the leadthrough so that the diaphragm sealingly engages the object, and, thereafter, sealingly connecting the support member with the constructional component.

According to the present invention, a leadthrough in a constructional components through which one or more strand-like object(s) is (are) inserted has its end side sealed with a diaphragm. As a diaphragm, a resilient diaphragm, which is surrounded by a support frame, is used. The support frame and the diaphragm are so selected that they are sufficiently large to completely cover the leadthrough. The leadthrough can have a cylindrical cross-section or any other regular and/or irregular cross-section. The support frame is so connected with the constructional component that it sealingly surrounds the leadthrough. The strand-like object extends into the leadthrough through the diaphragm which, due to its elasticity or resiliency, tightly engages the object so that the leadthrough is also sealed in the region of the object. The diaphragm, because of its structure or elasticity is in a position to accommodate objects having different diameters, and in an ideal case, no additional sealing measures are needed.

According to a first embodiment of the present invention, the leadthrough is covered by support frame which is sealingly connected with the constructional component, and the object is inserted through the diaphragm, which stretches across the support member, after the support member has been connected with the constructional component. Advantageously, the object extends into the leadthrough after it pierces the diaphragm. However, an insertion of the object in the opposite direction is also possible. In this case, the object is first inserted into the leadthrough and then pierces the diaphragm from behind. In the last case, the diaphragm-carrying support frame has to be first secured to the constructional component and be secured so that it does not disengage from the constructional component when the object is pushed through the diaphragm from behind.

According to an another embodiment of the inventive method, a resilient diaphragm, which is stretched across a support frame, is mounted on an end of an object already extending through the leadthrough, straddling the object, and then the support frame is sealingly connected with the constructional component. To this end, either the diaphragm is displaced along the object toward the constructional component or the diaphragm is displaced toward the constructional component together with the object.

With both methods, a very rapid and effective sealing of the leadthrough is achieved as the support frame sealingly abuts the constructional component, and the diaphragm, due to its resilient properties, sealingly surrounds the object that pierces the diaphragm. In order to achieve a sealing connection between the support frame and the constructional component, the support frame can be glued to the constructional component. This permits to effect both the connection of the support frame with the constructional component and the sealing of the leadthrough in a single step, which reduces the operational time. To this end, the support frame can be provided with a glutinous layer. Naturally, other forms of attachment and/or sealing can be used. Further, the support frame can have any suitable shape, rectangular, oval, circular, etc. The shape of the support frame depends, among others, on the shape of the leadthrough and the number of objects extendable through the leadthrough. When the leadthrough has a circular cross-section, and only one strand-like object extends therethrough, the support frame is formed, preferably, as a ring. In this case, the object pierces the diaphragm in its center. When two, spaced from each other, objects extend through the leadthrough, the support frame can have, e.g., a shape of an ellipse, with the two objects being located in respective focal point of the ellipse. This insures a particularly good sealing engagement of the diaphragm with both objects.

The diaphragm can be formed with at least one wall. This wall resiliently engages the circumference of the strand-like object extending through the diagram, providing a good slot sealing in the circumferential region of the object. By selection of resilient or elastic characteristics of the wall material and a suitable wall thickness, the wall of the diaphragm can be adapted to different sealing requirements.

In accordance with a further embodiment of the present invention, the diaphragm can include several spaced from each other walls supported in a common support frame, which increases the sealing properties of the diaphragm.

The diaphragm walls can have, in predetermined locations, openings through which a strand-like object can extend. The cross-section of the opening is always smaller than the cross-section of the object to-be-pushed therethrough. As a result, the diaphragm tightly engages the outer circumference of the object. However, the wall or walls of the diaphragm can be continuous which are pierced upon the object being pushed therethrough. With a continuous wall or walls, a particularly tight contact of the diaphragm with the object is achieved, which further improves the sealing effect.

In accordance with a still further embodiment of the present invention, with a diaphragm formed of several walls, which are spaced from each other, a sealing medium fills the space between the walls. As a sealing medium, a w viscous fluid, such as gel or hydrogel, can be used.

When such a diaphragm has continuous walls, the walls are destroyed when an object is pushed therethrough, and tightly engage the object. However, the viscous fluid cannot leak as the diaphragm walls which tightly engage the object, prevent leakage. In addition, the displacement of the fluid in the interior of the diaphragm increases the inner pressure between the walls, which further increases the sealing effect in the circumferential region of the object. The viscous fluid, thus, functions as additional sealing means or medium.

However, the sealing medium need not be limited exclusively to the viscous fluid. Rather, solid sealing medium such as, e.g., as a fine-grain substance or powder can be used.

The sealing medium, advantageously, has swelling properties. The viscous fluid, fine-grain substance, powder, and the like are used for sealing against dust (together with the diaphragm walls). An additional sealing against moisture or penetration of water or other medium from outside is achieved by using the viscous fluid, fine-grain substance, or powder provided with swelling properties. Upon penetration, e.g., of water into the interior of the diaphragm, the viscous fluid, fine-grain substance, powder, etc. swells and further seals the space in the circumferential region of the object. The swelling process can be initiated upon penetration of other than water medium, e.g., upon entrance of another fluid.

A diaphragm, which has the space between the walls filled with solid sealing means or with a viscous fluid, can also have an opening the cross-section of which is smaller than the cross-section of an object to-be-pushed therethrough. In this case, the diaphragm is formed as an annular chamber in which the solid sealing means or the viscous fluid is received. When the object, which has a greater cross-section than the diaphragm opening, is pushed through the diaphragm, the opening expands, and the diaphragm walls tightly engage the circumference of the pushed-through object. Also, the space between the walls, which circumferentially limits the opening, expands outwardly upon the object being pushed through the opening. Thereby, a relatively longer section of the object becomes engaged by the diaphragm walls. As a result, the sealing pressure applied to the object is produced not only due to the resiliency of the diaphragm walls but also due to pressure applied by the solid sealing means or by the viscous fluid filling the space between the walls. This combined sealing pressure in the region of the circumference of the object insures a very good sealing also against penetration of moisture or water or other fluid. Preferably, the solid sealing means or other viscous fluid, which fills the space between the walls, has swelling properties. When a swellable medium is used, in case of an inadvertent damage of the diaphragm, the medium swells, closing any opening formed as a result of the diaphragm being damaged.

According to a still further embodiment of the present invention, the diaphragm can take a funnel shape during its mounting on the object or when the object is pushed therethrough. In this case, the diaphragm clamps the object in the region of the smallest funnel width. To form a funnel shape, the object can be slightly displaced after mounting of the support frame. After a funnel is formed, a clamp, a band, or the like, can be used for further clamping the diaphragm with the object in the region of the funnel smallest width.

An implement for sealing a space between an inner wall of a lead-through formed in a constructional component and at least one object extending through the leadthrough includes a support member for closing the leadthrough, and a resilient diaphragm which stretches across the support member and through which the object is being pushed through when being inserted into the leadthrough.

The support frame can, e.g., be formed of plastics, metal, or any other suitable material. The size of the support frame is so selected that it completely closes the leadthrough in such a way that the resilient diaphragm, which is supported in the frame, completely closes the mouth opening of the leadthrough. The support frame can be provided, on its side surface, with a circumferential sealing ring or sealing lip for sealing the slot between the support frame and a surface of the constructional component to which the support frame is attached. The mounting of the support frame on the constructional component can be effected with any suitable attachment means. Alternatively, the support frame can be provided with a glutinous layer so that it can be tightly glued to the constructional component. This substantially facilitates mounting of the support frame. The glutinous layer can be protected with plastic strips which can be removed, pulled off, from the glutinous layer before the attachment of the support frame to the constructional component.

The diaphragm can have one or several walls formed, e.g., of rubber, plastic foil and the like. In any case, the wall material has to have the needed resiliency so that the diaphragm is not lacerated when a strand-like object is pushed therethrough. As a sealing medium, a viscous fluid, as it has already been discussed above, can be used. Also can be used, as it also has been discussed above, a fine-grain substance, powder, or the like. The used sealing means or medium can have swelling properties so that it would swell upon a contact with water or other medium which can cause swelling. As a viscous fluid, as discussed, gel or hydrogel can be used.

As it has already been discussed, the diaphragm can take a funnel shape when a strand-like object is pushed therethrough, and became clamped to the object in the region of the smallest funnel width. It is also possible to form the diaphragm with a funnel shape initially so that it more tightly engages an object which is pushed therethrough. With the funnel shape of the diaphragm being provided initially, the sealing surface between the diaphragm and the object increases upon insertion of the object, which improves the sealing characteristics of the sealing. Further, the diaphragm can be clamped to the object in the region of the smallest funnel width with additional clamping means.

According to an advantageous embodiment of the present invention, the support frame is provided with positioning elements extending into the leadthrough for positioning the support frame relative to the leadthrough or for positioning an object relative to the support frame. The positioning elements prevent an eccentric positioning of the support frame relative to the leadthrough, and prevent displacement of the object radially relative to the diaphragm. A radial displacement of the object would have resulted in a non-uniform loading of the diaphragm and in a resulting non-uniform sealing effect. Thus, the provision of the positioning elements further improves the sealing characteristics of the inventive implement. Advantageously, the positioning elements are formed as resilient stirrups, which insures a simple positioning of the support frame relative to the constructional component even when a leadthrough has a large cross-section. Because the stirrups have resilient properties, they are capable of proper positioning of objects, which have different cross-sections, relative to the support frame or the diaphragm.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS:

The drawings show:

FIG. 1 a perspective view of sealing implement according to the present invention for sealing an opening in a constructional component;

FIG. 2 a view showing the sealing implement shown in FIG. 1 in its inserted condition with a strand-like object extending therethrough;

FIG. 3 an axial cross-sectional view through the arrangement shown in FIG. 2;

FIG. 4. a view showing a second embodiment of a sealing implement according to the present invention with a funnel-shaped diaphragm; and

FIG. 5. a view showing the sealing implement shown in FIG. 4 with a strand-like object extending therethrough.

### DETAILED DESCRIPTION OF THE PREFERRED EMBODIMENT

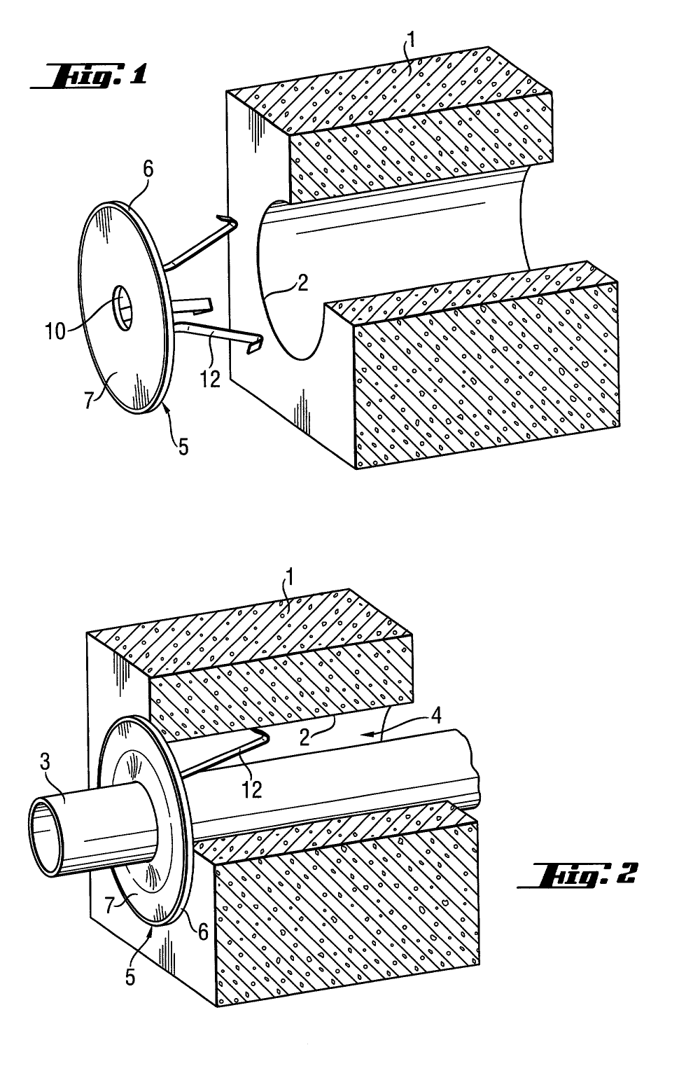

FIGS. 1 through 3 show, in addition to a sealing implement 5 according to the present invention, also a constructional component 1 an opening in which is to be sealed with the sealing implement 5. The constructional component 1 can be, e.g., a wall of a building. The constructional component 1 has a leadthrough 2 the inner diameter of which is more or less known. The leadthrough 2 has essentially a shape of a hollow cylinder. However, generally, a constructional component can have a leadthrough with unregular cross-section. A strand-like or tubular object 3, e.g., a cable, a pipe, or the like can extend through the leadthrough 2. When the object 3 extends through the leadthrough 2, an annular slot 4 is formed between the wall of the leadthrough 2 and the object 3.

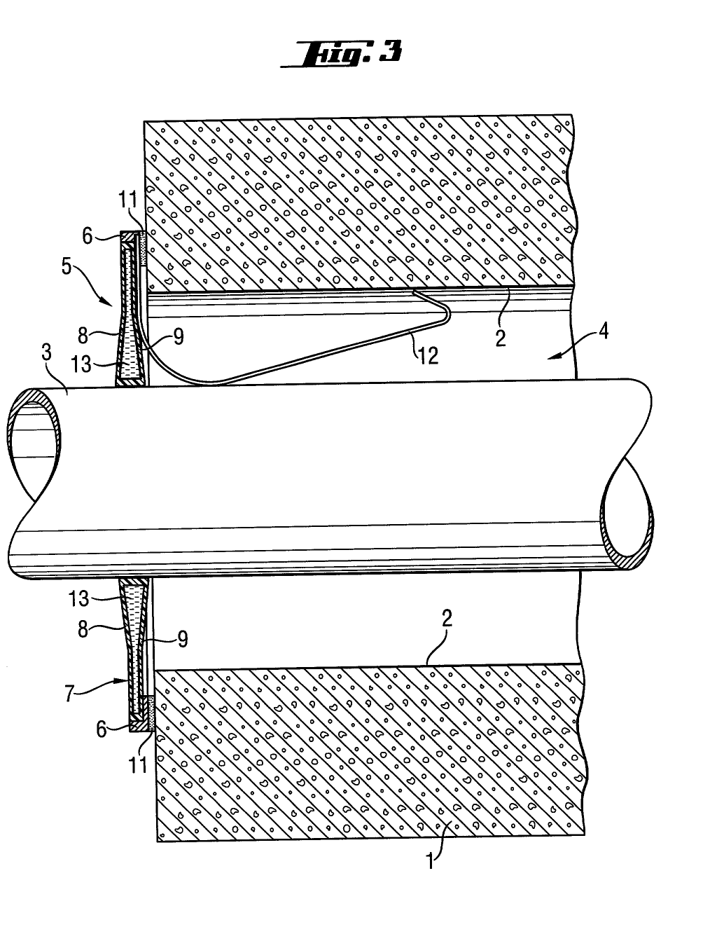

For sealing the annular slot 4, the sealing implement 5 according to the present invention is used. The sealing implement 5 has a shape of a diaphragm and includes a circular support frame 6 formed, e.g., of a plastic material, metal, or the like. A diaphragm 7 extends across the support frame 6. The diaphragm 7 is formed as a resilient part and has two resilient or elastic walls 8 and 9. The walls 8 and 9 extend parallel to each other at a small distance from each other. The walls 8 and 9 lie within the plane of the support frame 6. The diaphragm 7 has a central opening 10 which is formed of through-openings formed in the walls 8 and 9 and the edges of which are connected by the material the walls 8 and 9 are formed of. In other words, the diaphragm 7 includes a hollow space which is limited, on one hand, by walls 8 and 9 and, on the other hand, by a web, which limits the opening 10 and by the support frame 6. The opening 10 has a diameter that is smaller than a diameter of the object 3 to be extended through the opening 10. The web, which limits the opening 10, can be formed as one-piece with the walls 8 and 9 and can have the same thickness as the walls 8 and 9. When the web, which limits the opening 10, is formed of the same material as the walls 8 and 9, it would have the same elasticity and would tightly surround the object 3, with the object 3 extending through the opening 10. The position, in which the object 3 extends through the opening 10 of the diaphragm 7, is shown in FIGS. 2-3.

The hollow space of the diaphragm 7 is filled with a very viscous fluid 13, e.g., with hydrogel. When the object 3 penetrates through the opening 10, it expands the opening 10, reducing the volume occupied by the viscous fluid 13. Thereby, an additional pressure is applied to the wall region of the diaphragm 7 which surround the object 3. This increases the sealing properties of the diaphragm 7.

A sealing element 11, which is arranged on one side of the diaphragm 7, is connected with the support frame 6. The sealing element 11 can be formed as a glutinous layer glued to the support frame 6. The glutinous layer 11 fixedly and sealingly connects the support frame 6 to a surface of the constructional component 1. Because the inner diameter of the support frame 6 is larger than the inner diameter of the leadthrough 2, the diaphragm 7, which stretches over the cross-section of the support frame 6, completely covers the leadthrough 2.

The support frame 6 has resilient stirrups 12 secured thereto. In the embodiment shown in FIGS. 1-3, three resilient stirrups 12 are secured to the periphery of the support frame 6 and are equidistantly angularly spaced from each other. The stirrups 12 extend radially inward and then are so bent in the axial direction that they again extend upward, away from the support frame 6. At their free ends, the stirrups 12 are again bent outwardly, this time, toward the support frame 6. In this way, the free ends of the stirrups 12 can be supported against the wall of the leadthrough 2, while the convex regions of stirrups 12, which are located adjacent to the diaphragm 7, are supported against the object 3, positioning the same.

The mounting of the sealing implement 5 is effected as follows. After the glutinous layer 11 is put on the support frame 6, the stirrups 12 of the sealing implement 5 are pushed into the leadthrough 2 until the glutinous layer 11 contacts the wall of the constructional component 1. Then, the support frame 6 is pressed against the wall of the constructional component 1, whereby a rigid and sealing connection of the support frame 6 with the constructional component 1 is achieved. The stirrups 12 position the support frame 6 relative to the leadthrough 2 in such a way that the support frame 6 becomes concentric with the leadthrough 2. This is achieved by the free ends of the stirrups 12 being correspondingly supported against the wall of the leadthrough 2. After the sealing implement 5 has been mounted, the object 3, cable or pipe, is pushed through the opening 10 of the diaphragm 7 and into the leadthrough 2. The insertion of the object 3 is effected from left to right. The diaphragm 7 sealingly engages the object 3, whereby a very good sealing of the annular slot 4 is achieved.

Contrary to the design of the sealing implement 5 according to FIGS. 1-3, the diaphragm walls 8 and 9 can be connected with each other at their upper edges and enclose the sealing medium therebetween. The sealing medium, as in the embodiment of FIGS. 1-3, can comprise a viscous fluid, e.g., hydrogel. The mounting of the sealing implement 5 is effected in the manner described above until the support frame 6 sealingly engages the wall of the constructional component 1. Then the object 3 is inserted through the diaphragm 7 and into the leadthrough 2 and is positioned in its final position. Because of the resiliency of the diaphragm 7 and because of the displacement of the sealing fluid, the inner pressure of the sealing fluid between the diaphragm walls increases, whereby the slot 4 becomes reliably sealed.

With both embodiments of the sealing implements, the sealing medium, e.g., the hydrogel, can swell so that with any damage of the diaphragm walls, an eventual penetration of water or any other medium would lead to swelling or to increase of volume of the sealing medium. The swelling or the increase of volume would compensate the damage of the walls. Moreover, the swelling effect can be desirable in the circumferential region of the strand-like object 3 to achieve an even better sealing of the annular slot when there is a possibility that moisture, water, or the like can penetrate in the region between the diaphragm walls and the object.

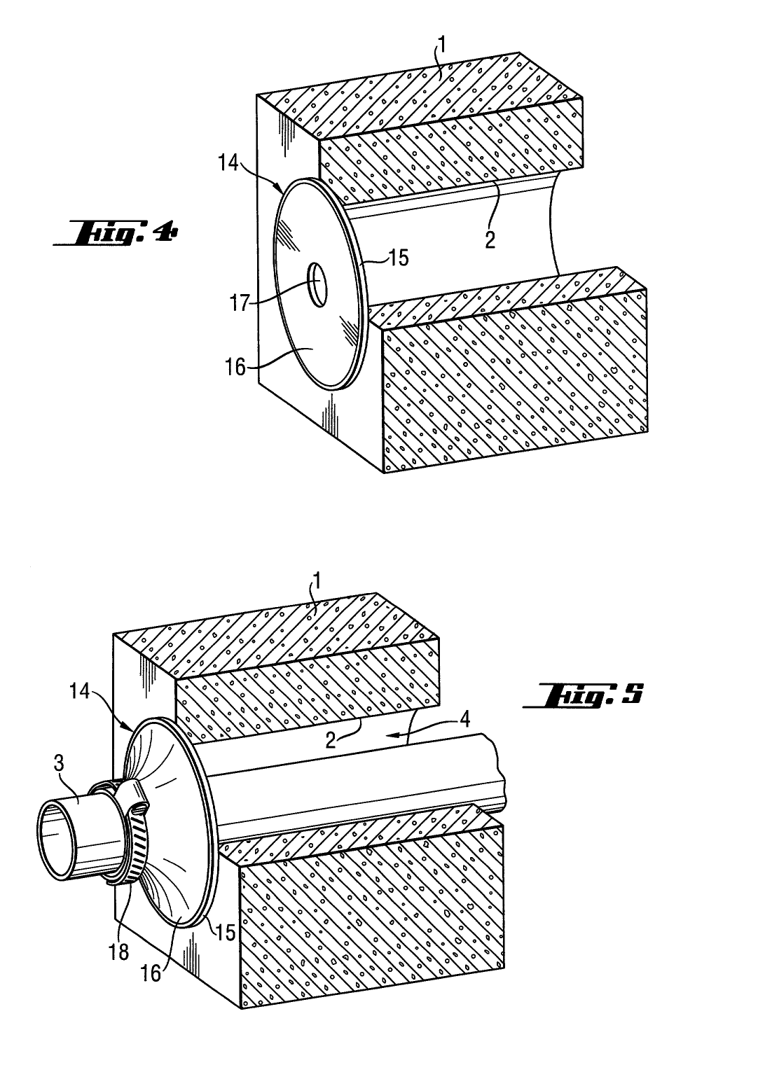

A further embodiment of a sealing implement according to the present invention is shown in FIGS. 4-5. The sealing implement 14 of this embodiment has a support ring 15 corresponding to the support frame 6 of the embodiment of the sealing implement shown in FIGS. 1-3. The support ring 15 can also be provided with resilient stirrups (not shown) similar to those shown in FIGS. 1-3. The support ring 15, as the support frame 6, can be fixedly and sealingly connected with the constructional component 1 by a glutinous layer (not shown) so that it is concentric with the leadthrough 2, surrounding same. A diaphragm 16 of the sealing implement 14 is received in the support ring 15. The diaphragm 16 can be formed as a rubber wall with a central opening 17 having a diameter smaller than a diameter of the object 3 to-be-pushed therethrough.

FIG. 5 shows a condition in which the strand-like object 3 has been pushed through the diaphragm 16. The object 3 is pushed from left to right through the diaphragm 16 which, as a result, has been set back or entrained by the object 3 as a result of friction. In this way, the diaphragm 16 forms a funnel-shaped shell. Due to the resiliency of the diaphragm 16, the shell sealingly engages the object 3, sealing the annular slot. By pulling the object 3 back or leftwards, the funnel turns up outwardly. For securing the diaphragm 16 on the object 3, a hose clamp 18 can be used which clamps the diaphragm 16 on the object 3. The clamp 18 further increases pressure applied to the object 3 and prevents pulling of the object 3 out of the leadthrough. As it has already been mentioned above, for centering the strand-like object 3 relative to the support ring 15 and/or for centering of the support ring 15 relative to the leadthrough 2, corresponding stirrups can be secured to the support ring 15.

Though the present invention was shown and described with references to the preferred embodiments, such are merely illustrative of the present invention and are not to be construed as a limitation thereof, and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

What is claimed is:

1. A method of sealing a space (4) between an inner wall of a leadthrough (2) formed in constructional component (1) and at least one object (3) extending through the leadthrough (2), the method comprising the steps of providing a sealing implement (5; 14) having a support member (6; 15) and a resilient diaphragm (7; 16) stretching across the support member (6; 15); sealingly connecting the support member (6; 15) with the constructional component (1); and pushing the object (3) through the diaphragm (7; 16).

2. A method of sealing a space (4) between an inner wall of a leadthrough (2) formed in constructional component (1) and at least one object (3) extending through the leadthrough (2), the method comprising the steps of providing a sealing implement (5; 14) having a support member (6; 15) and a resilient diaphragm stretching across the support member (6; 15); pushing the object (3) through the leadthrough (2); mounting the sealing implement (5; 14) on an end of the object (3) projecting from the leadthrough (2) so that the diaphragm (7; 16) sealingly engages the object (3); and sealingly connecting the support member (6; 15) with the constructional component (1).

3. A method according to claim 1, wherein the sealing implement providing step includes providing a sealing implement having a diaphragm (16) formed of a single wall.

4. A method according to claim 1, wherein the sealing implement providing step includes providing a sealing implement having a diaphragm (7) formed of a plurality of spaced from each other walls (8, 9), with a space between the walls (8, 9) being filled with one of solid sealing means and a viscous fluid (13).

5. A method according to claim 3, wherein the pushing step includes distorting the diaphragm wall when the object is pushed therethrough.

6. A method according to claim 4, wherein the pushing step includes distorting the diaphragm walls when the object is pushed therethrough.

7. A method according to claim 3, wherein the pushing step includes pushing the object (3) through an opening (10; 17) formed in the diaphragm (7; 16) and a diameter of which is smaller than a diameter of the object (3).

8. A method according to claim 5, wherein the pushing step includes distortion of the diaphragm wall so that the diaphragm (14) takes a shape of a funnel and becomes clamped to the object (3) in a region of a smallest funnel width.

9. A method according to claim 7, wherein the pushing step includes pushing the object (3) through coaxial openings (10) formed in the diaphragm walls (8, 9) and a diameter of which is smaller than a diameter of the object (3).

10. A method according to claim 1, wherein the sealingly connecting step comprises gluing of the support member (6; 15) to the constructional component (1).

11. A method according to claim 2, wherein the sealing implement providing step includes providing a sealing implement having a diaphragm (16) formed of a single wall.

12. A method according to claim 2, wherein the sealing implement providing step includes providing a sealing implement having a diaphragm (7) formed of a plurality of spaced from each other walls (8, 9), with a space between the walls (8, 9) being filled with one of solid sealing means and a viscous fluid (13).

13. A method according to claim 11, wherein the pushing step includes piercing the diaphragm wall when the object is pushed therethrough.

14. A method according to claim 12, wherein the pushing step includes piercing the diaphragm walls when the object is pushed therethrough.

15. A method according to claim 11, wherein the pushing step includes pushing the object (3) through an opening (10; 17) formed in the diaphragm (7; 16) and a diameter of which is smaller than a diameter of the object (3).

16. A method according to claim 13, wherein the pushing step includes distortion of the diaphragm wall so that the diaphragm (14) takes a shape of a funnel and becomes clamped to the object (3) in a region of a smallest funnel width.

17. A method according to claim 15, wherein the pushing step includes pushing the object (3) through coaxial openings formed in the diaphragm walls (8, 9) and a diameter of which is smaller than a diameter of an object.

18. A method according to claim 2, wherein the sealingly connecting step comprises gluing of the support member (6; 15) to the constructional component (1).

19. An implement for sealing a space (4) between an inner wall of a leadthrough (2) formed in a constructional component (1) and at least one object (3) extending through the leadthrough (2), the implement (5; 14) comprising a support member (6; 15) for closing the leadthrough (2); and a resilient diaphragm (7; 16) which stretches across the support member (6; 15) and through which the object is being pushed.

20. An implement according to claim 19, wherein the diaphragm (16) has a single wall.

21. An implement according to claim 19, wherein the diaphragm (7) has a plurality of spaced from each other walls (8, 9), with a space between the walls (8, 9) being filled with one of solid sealing means and viscous fluid (13).

22. An implement according to claim 20, wherein the wall is continuous and is distorted upon the object being pushed therethrough.

23. An implement according to claim 21, wherein the walls are continuous and are distorted upon the object being pushed therethrough.

24. An implement according to claim 19, wherein the diaphragm (7; 16) has an opening (10; 17) through which the object is pushed and which has a diameter smaller than a diameter of the object (3).

25. An implement according to claim 20, wherein the diaphragm (16) has a shape of a funnel.

26. An implement according to claim 19, further comprising a sealing element (11) provided on a side circumferential surface of the support member (6; 15).

27. An implement according to claim 26, wherein the sealing element (11) is formed as a glutinous layer.

28. An implement according to claim 21, wherein the solid sealing means comprises one of fine-grained substance and powder.

29. An implement according to claim 21, wherein the viscous fluid (13) comprises a hydrogel.

30. An implement according to claim 21, wherein the solid sealing means and the viscous fluid have a swelling capability.

31. An implement according to claim 19, comprising clamp means (18) for clamping a region of the diaphragm (16) adjacent to the object (3) to the object (3).

32. An implement according to claim 19, further comprising positioning elements (12) connected with the support member (6) and extending into the leadthrough (2) for one of positioning of the support member (12) relative to the leadthrough (2) and positioning of the object (3) relative to the support member (6).

33. An implement according to claim 32, wherein the positioning elements (12) are formed as resilient stirrups.
